(19) United States
(12) Patent Application Publication
(10) Pub. No.: US 2023/0141261 A1
(43) Pub. Date: May 11, 2023

(54) Hard Armor Trade Space Analysis System

(71) Applicant: The Government of the United States of America, as represented by the Secretary of the Navy, Arlington, VA (US)

(72) Inventors: Alex E. Moser, Alexandria, VA (US); Nicholas D. Pierce, Ruther Glen, VA (US); Cherelda V. Stephens, Stafford, VA (US)

(73) Assignee: The Government of the United States of America, as represented by the Secretary of the Navy, Arlington, VA (US)

(21) Appl. No.: 17/862,621

(22) Filed: Jul. 12, 2022

Related U.S. Application Data
(60) Provisional application No. 63/230,193, filed on Aug. 6, 2021.

(51) Int. Cl. G06F 16/2457

(52) U.S. Cl. CPC G06F 16/24575; F41H 5/00

(57) ABSTRACT

A technique for determining armor weight requirements for a specific set of ballistic threats at specific stand-offs or velocities allows for the selection of armor that is not excessively heavy, thus improving mobility, comfort, and survivability.

### CROSS-REFERENCE TO RELATED APPLICATIONS

This application claims the benefit of U.S. Provisional Patent Application No. 63/230,193 filed on Aug. 6, 2021, the entirety of which is incorporated herein by reference.

### FEDERALLY-SPONSORED RESEARCH AND DEVELOPMENT

The United States Government has ownership rights in this invention. Licensing inquiries may be directed to Office of Technology Transfer, US Naval Research Laboratory, Code 1004, Washington, D.C. 20375, USA; +1.202.767.7230; techtran@nrl.navy.mil, referencing NC 112191.

### BACKGROUND

The U.S. Marine Corps primarily fields a single type of hard armor system called the Enhanced Small-Arms Protective Insert (ESAPI), comprised of a sandwiched armor component structure. The existing Enhanced SAPI (ESAPI) plates are heavy (5.5 pounds per plate for a medium sized plate), and contribute to increased load bearing injuries and decreased mobility survivability. These plates are engineered to stop penetration of specific threats at the designated threats' muzzle velocity. The primary and most severe threat the ESAPI is rated for is rarely used in operation by either allied or adversarial forces. Also, the specific threats in most combat situations are predominantly and significantly below the threats rated muzzle velocity. Thus, in 90% of battlefield scenarios, these plates are overrated for penetration performance but underperform with respect to mobility and overall survivability. As part of the Marine Corps mission, an attempt is being made to maintain adequate penetration performance while decreasing plate weight and increasing mobility.

A need exists for a technique to determine the required penetration performance for a specific set of threats in order to optimize armor weight.

### BRIEF SUMMARY

In one embodiment, a method of selecting an armor system based on a threat having a given velocity includes providing a database comprising (1) a listing of armor plates, each having associated therewith a mass, an area, and an energy per armor area, Eₐ; and (2) a listing of ballistic threats, each having associated therewith data sufficient to determine threat projected energy, Eₙ, presented by the threat at a provided velocity, wherein Eₙ is a kinetic energy of the threat at said velocity divided by a projected area of the threat; receiving an input comprising a threat and a threat velocity; determining a threat Eₙ of the threat at the threat velocity; comparing the threat Eₙ to the Eₐ of the armor plates to obtain a group of armor plates each having an Eₐ greater than or equal to the threat Eₙ; determining the effective toughness of each armor plate in the group based on the values stored in the database for the plate's mass, area, and energy per armor area; and then providing an output listing comprising armor requirements to defeat the threat at the threat velocity.

In another embodiment, a method of selecting an armor system based on a threat having a given standoff distance includes providing a database comprising (1) a listing of armor plates, each having associated therewith a mass, an area, and an energy per armor area Eₐ; and (2) a listing of ballistic threats, each having associated therewith ballistics information sufficient to determine a threat velocity at a given standoff distance and data sufficient to determine threat projected energy, Eₙ, presented by the threat at a given velocity, wherein Eₙ is a kinetic energy of the threat divided by a projected area of the threat; receiving an input comprising a threat and a standoff distance; determining a threat velocity from the standoff distance; determining a threat Eₙ of the threat at the threat velocity; comparing the threat Eₙ to the Eₐ of the armor plates to obtain a group of armor plates each having an Eₐ greater than the threat Eₙ; determining the toughness of each armor plate in the group based on the values stored in the database for the plate's mass, area, and energy per armor area; and then providing an output listing comprising armor requirements to defeat the threat at the standoff distance.

In a still further embodiment, a method of selecting an armor system based on a threat at muzzle velocity includes providing a database comprising (1) a listing of armor plates, each having associated therewith a mass, an area, and an energy per armor area, Eₐ; and (2) a listing of ballistic threats, each having associated therewith data sufficient to determine threat projected energy, Eₙ, at a muzzle velocity of the threat; receiving an input comprising a threat; determining a threat Eₙ of the threat at the threat muzzle velocity; comparing the threat Eₙ to the Eₐ of the armor plates to obtain a group of armor plates each having an Eₐ greater than the threat Eₙ; determining the effective toughness of each armor plate in the group based on values stored in the database for the plate's mass, area, and an energy per armor area; and then providing an output listing comprising the armor plate in the group having the greatest toughness.

In various aspects, the data sufficient to determine Eₙ includes (a) a threat maximum diameter and a threat mass, and said determining Eₙ at said threat velocity comprises calculating said kinetic energy of the threat and said projected area of the threat; or (b) values for threat kinetic energy E and/or threat projected energy Eₙ that have already been determined for at least one threat velocity.

### BRIEF DESCRIPTION OF THE DRAWINGS

FIGS. 1A-1D show various performance representations of data from the armor database.

FIGS. 2A-2D show the same source data as plotted in FIGS. 1A-1D following analysis. The line in FIG. 2A fit with y=1.86037E+07x and R²=0.976857. The line in FIG. 2C fit with y=1.85527E+07x and R²=0.9970283.

FIG. 3 is a schematic showing the threat area projection in-process of striking an armor plate segment (gray). As seen in the circular areas below the projectiles (darker gray), the 7.62 mm diameter threat projects a larger area than the 5.56 mm diameter threat resulting in a larger distribution of the energy over the armor plate and armor volume.

FIGS. 4A and 4B are an exemplary analysis comparing two threats and various stand-off distances.

### DETAILED DESCRIPTION

Definitions

Before describing the present invention in detail, it is to be understood that the terminology used in the specification is for the purpose of describing particular embodiments, and is not necessarily intended to be limiting. Although many methods, structures and materials similar, modified, or equivalent to those described herein can be used in the practice of the present invention without undue experimentation, the preferred methods, structures and materials are described herein. In describing and claiming the present invention, the following terminology will be used in accordance with the definitions set out below.

As used herein, the singular forms “a”, “an,” and “the” do not preclude plural referents, unless the content clearly dictates otherwise.

As used herein, the term “and/or” includes any and all combinations of one or more of the associated listed items.

As used herein, the term “about” when used in conjunction with a stated numerical value or range denotes somewhat more or somewhat less than the stated value or range, to within a range of±10% of that stated.

As used herein, the term “standoff distance” refers to a distance between armor and the muzzle of a source of a ballistic threat against that armor.

Overview

A described herein is a technique for determining armor weight requirements for a specific set of ballistic threats at specific stand-offs or velocities. This allows for the design of armor that is not excessively heavy, thus improving mobility and comfort. Furthermore, increasing combat load was found to significantly increase causalities in simulations (see Thompson C., “Paying for weight in blood: An analysis of weight and protection level of a combat load during tactical operations.” Naval Postgraduate School, Monterey, Calif., USA, 2019), so that overall survivability might paradoxically be improved with lighter armor.

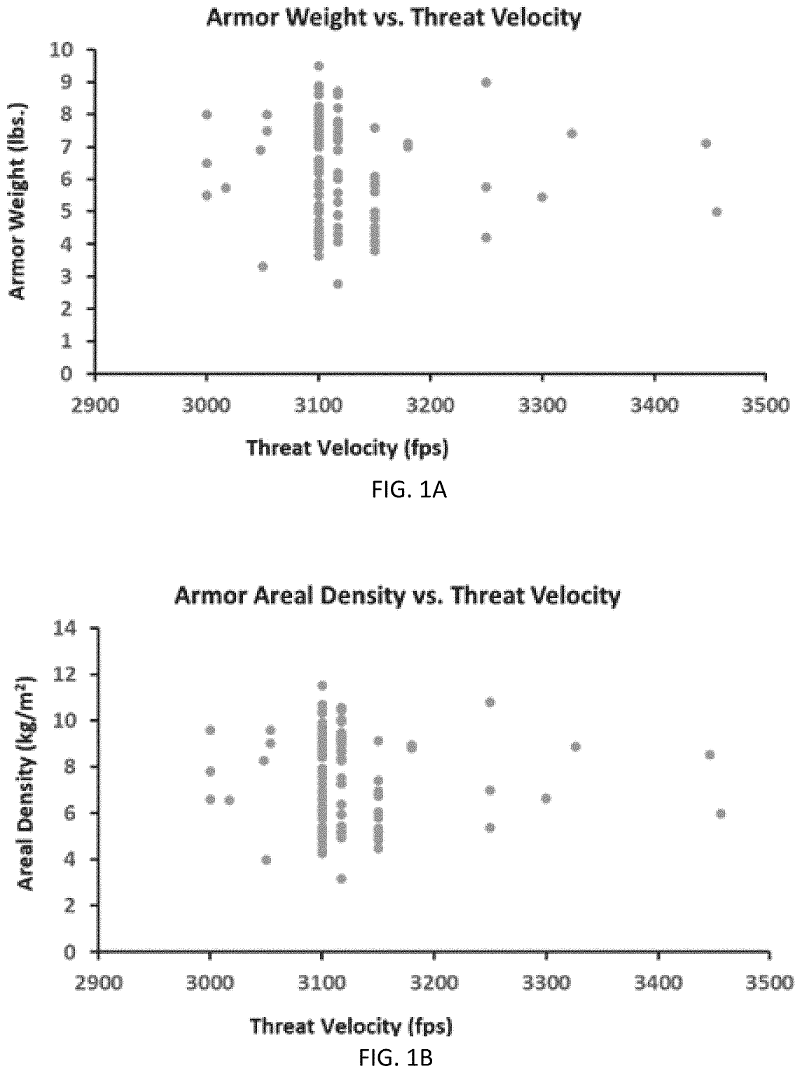

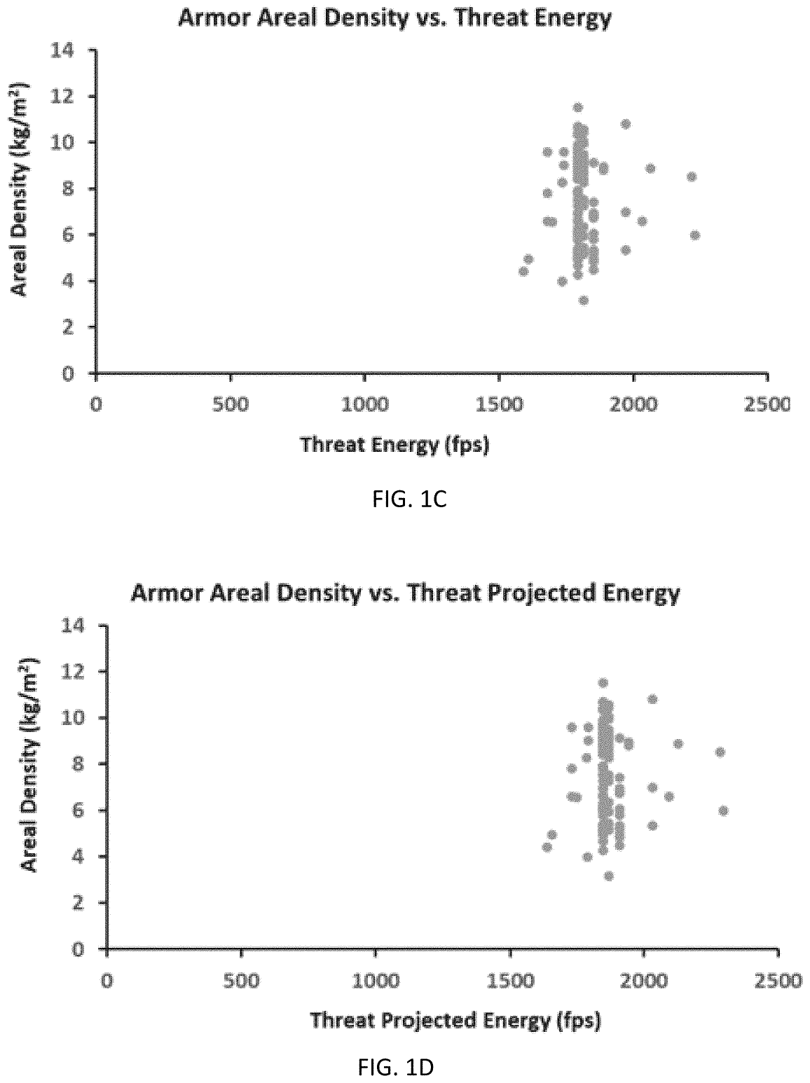

As shown in FIGS. 1A-1D, a variety of analyses of armors plotted against various characteristics of a threat failed to reveal any useful pattern. For example, plotting the native armor weight vs. the non-penetrating threat velocity reveals nothing of apparent value. Nor does plotting (1) armor weight vs. threat velocity, (2) armor areal density vs. threat velocity, (3) armor areal density vs. threat energy, nor (4) armor areal density vs. threat projected energy reveal any useful pattern in the data. Essentially, the data in the plots of FIGS. 1A-1D represent extrinsic data (weight and velocity), or data are not normalized appropriately, or both.

Normalization of data allows for a useful comparison of the performance of various armor systems. In particular, data can be treated as follows.

Armor weights can be normalized to areal density, σₐ

$${σ}_{a} = \frac{Armor Mass}{Armor Area}$$

Threat kinetic energy E can be obtained by the equation

$$E = \frac{1}{2} m {v}^{2}$$

where m is the mass of the threat projectile and v is the threat velocity, which is the projectile velocity at the point of projectile contact with the armor.

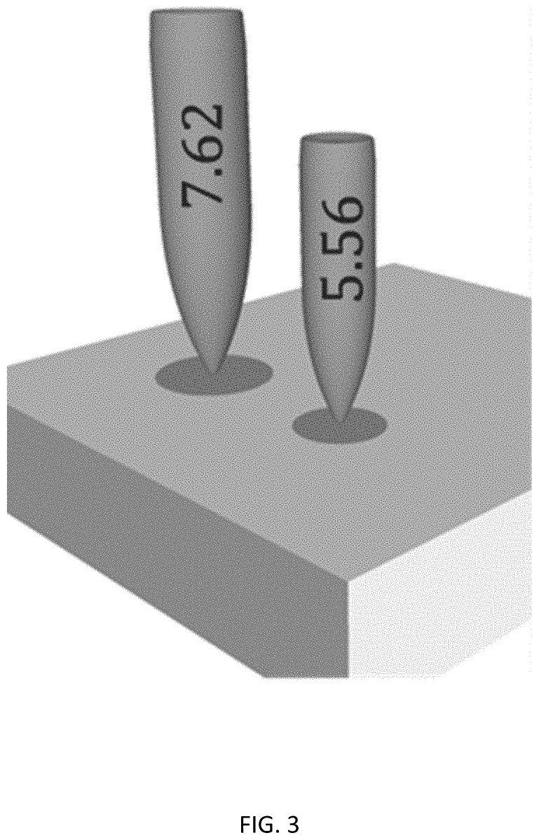

The threat projected area Aₜ can be computed from the maximum diameter d of the threat projectile as shown in FIG. 3 by using the formula

$${A}_{t} = {π ( \frac{d}{2} )}^{2}$$

Threat kinetic energy, E, can be normalized to an energy flux, Eₙ, from the threat energy, E, per unit threat projected area, Aₜ, also termed threat projected energy

$${E}_{n} = \frac{E}{{A}_{t}}$$

An energy per armor area, Eₐ, represents the amount of energy per unit area that can be absorbed by the armor. For an armor system to be effective against a given threat, the threat projected energy Eₙ must be countered by Eₐ. Thus, one wishes for Eₐ≥Eₙ in order to defeat the threat, optionally with a further safety factor so that Eₐ is sufficiently greater than Eₙ. In various aspects, a safety factor can be included by multiplying Eₙ by a number greater than one, or adding a positive value to Eₙ, or both, prior to the comparison with Eₐ. Eₐ can be determined empirically via ballistic testing.

From these, armor system mass toughness, Tₘ, can be determined

$${T}_{m} = \frac{{E}_{a}}{{σ}_{a}}$$

A database can facilitate analysis to help make a selection of an armor system sufficient to meet expected threats. A suitable database includes a listing of armor systems and a listing of threats.

In the listing of armor systems, each system has associated with it a mass, an area, and an energy per armor area (Eₐ). The Eₐ for each armor system can be demonstrated through certified ballistic tests and can be considered to generally represent the energy that will be absorbed by an area unit of the armor.

In the listing of threats, each threat has associated with it data sufficient to determine threat projected energy, Eₙ, presented by threat from at least one standoff distance (including a standoff distance of zero, representing muzzle velocity). In one embodiment, the threat data includes a projected area (generally corresponding to the maximum diameter of the projectile), a mass for the threat projectile, and ballistics information representing muzzle velocity and the velocity at various standoff distances. In another embodiment, the threat data includes values for threat kinetic energy E and/or threat projected energy Eₙ that have already been determined for at least one standoff distance or velocity. In a further embodiment, the threat data includes parameters sufficient to compute projectile velocity at any given standoff distance from zero to the maximum practical range for the threat, and optionally beyond that distance.

Threat velocity can be (1) entered directly as an input or (2) computed based on the stand-off distance of the threat. In the latter case, threat velocity is obtained using standard methods relating the velocity as a function of stand-off based on ballistics information existing in the database.

In using the database, an input is provided than can includes a specific threat from the listing of threats. In various embodiments, the input can also comprise a threat velocity or a standoff distance—if neither is provided, then the analysis can proceed based on the muzzle velocity of the threat. From this, the threat Eₙ can be determined as described above. The threat Eₙ is compared to the Eₐ of each of the armor plates in the database to obtain a group of armor plates having an Eₐ value greater than or equal to the threat Eₙ (optionally with the safety factor so that the value is sufficiently greater). This enables the system to provide an output listing of armor requirements sufficient to defeat the threat.

In selecting an armor system, the Eₙ of the threat with the highest value thereof can divided by the plate with the highest toughness Tₘ to obtain the lowest armor areal density possible to stop the threat set and the threat with the highest Eₙ. Further, the obtained areal density can be multiplied by the area for a given plate size (for example, a medium ESAPI armor plate), to obtain the minimum plate weight needed to provide the required protection coverage at minimum weight to stop the threat set.

The output listing can be configured to provide a variety of information. For example, it can include the minimum plate as noted above, a listing of all plates in the group found to defeat the threat and optionally their weights, and other information, including combinations of these. The output listing could be a short as a single item, or an indication that none of the armor plates in the database are sufficient to defeat the threat. The database preferably permits a user to search and sort any combination of armor, threat for which the armor was tested, velocities for which the armor was tested, armor company manufacturers, test data sheets provided by certified ballistic test ranges, and practically any other parameter.

The database system runs on conventional computer software and hardware. The user interface can include a display screen and means for receiving user input. Such means can one or more of a keyboard, mouse, trackball, touchscreen, voice recognition, and other user interface devices known in the art. In various aspects, the database can operate on the same hardware system as the user interface, or the two can be connected by, for example, a computer network. Such a network could include a connection to a distributed database system, or to a server containing a centralized database system.

Examples

A database system was created to analyze the hard armor trade space (HATS). The HATS analysis evaluated publicly-obtained information from vendor web sites as well as vendor proprietary information that was made available for the analysis. Some vendor proprietary information typically consisted of vendor ballistic test reports of commercial off the shelf (COTS) armor plate performed at certified commercial ballistic test laboratories.

The HATS analysis system includes a database of armor manufacturer hard armor plates, prevalent ballistic threats, ballistic test data from threats for which each plate was tested, and scripts to perform analysis on COTS plates in the database. The database was a relational, many-to-many, database including 16 unique tables and 36 unique data fields for user data entry, a custom search engine, and sort capability to find and filter the data ensembles within the database.

The data includes armor plate specifications from 38 manufacturers with 229 hard distinct hard armor systems, and also includes 42 small arms ballistic threats. The data was intentionally limited to plate systems close to the ESAPI medium size format to avoid duplicate performance information.

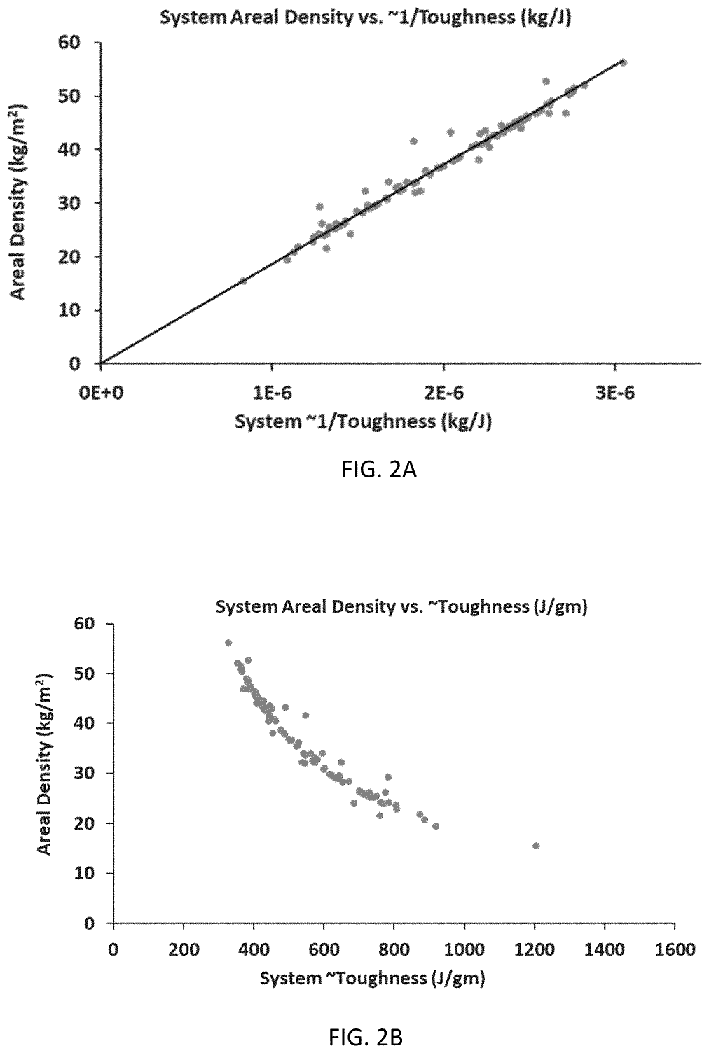

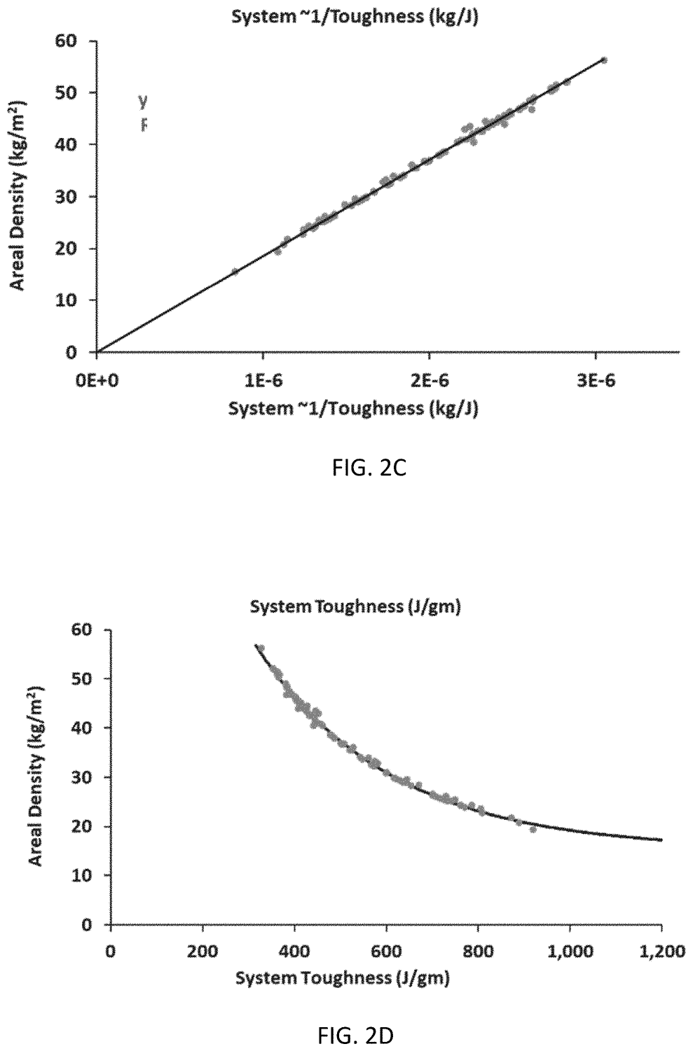

Analysis of the data within the database using normalized ballistic threat and armor data produces results capable of determining armor weight requirements dependent on the set of threats, each at specific velocities or stand-offs. The same data shown in FIGS. 1A-1D is presented in FIGS. 2A-2D, but the data is normalized to give clear meaning to the data. The data can be further filtered to remove data that is either suspect, unverified, or otherwise not useful for the analysis. The plots in FIGS. 2A-2D are a graphical representation of the analysis. The analysis uses a set of scripts to make a single armor plate weight determination from the data represented in the FIGS. 2A-2D plots.

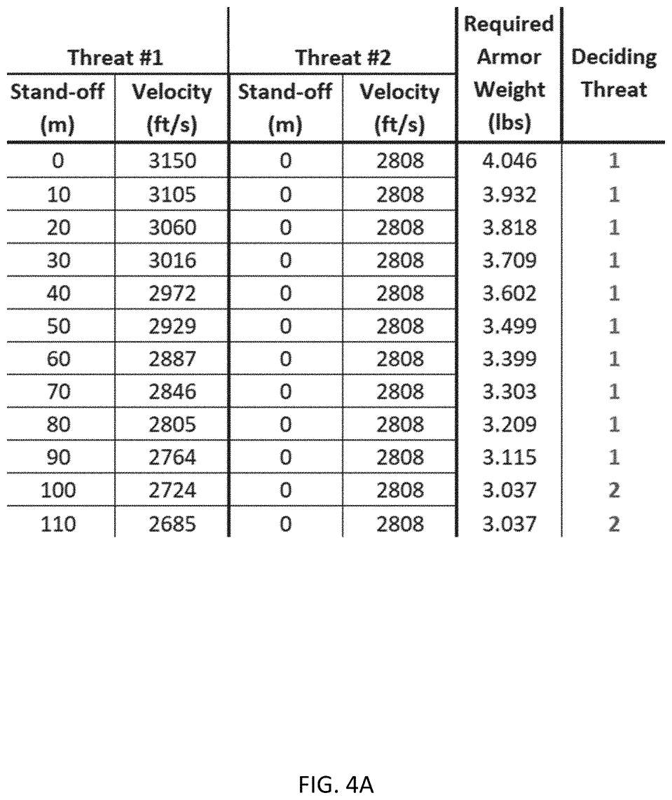

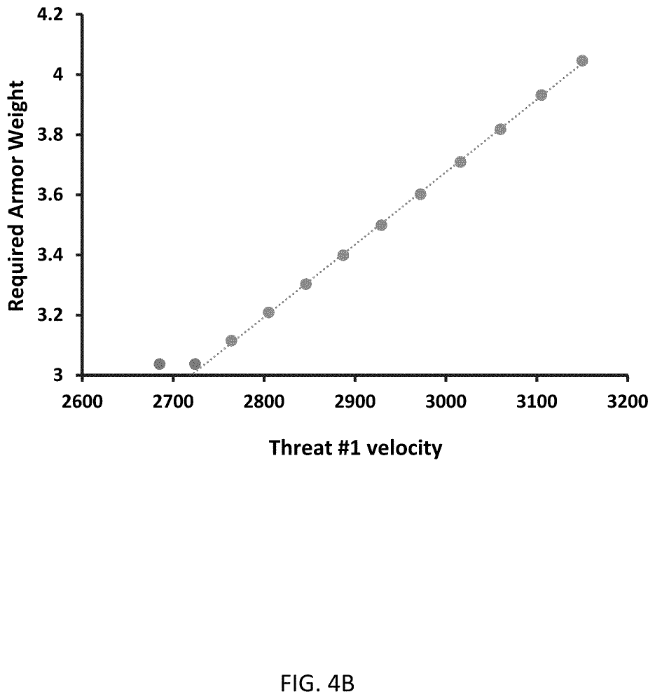

FIGS. 4A and 4B are an exemplary analysis of two representative threats. The data are from real-world threats that are identified only as “Threat #1” and “Threat #2” due to the sensitivity of the information. FIG. 4A is an output listing that includes the required armor weight to meet the set of two threats at each stand-off distance. As depicted graphically in FIG. 4B, as the velocity from Threat #1 drops with distance, Threat #2 becomes the dominant threat.

What is claimed is:

1. A method of selecting an armor system based on a threat having a given velocity, the method comprising:
providing a database comprising (1) a listing of armor plates, each having associated therewith a mass, an area, and an energy per armor area, Eₐ; and (2) a listing of ballistic threats, each having associated therewith data sufficient to determine threat projected energy, Eₙ, presented by the threat at a provided velocity, wherein Eₙ is a kinetic energy of the threat at said velocity divided by a projected area of the threat;
receiving an input comprising a threat and a threat velocity;
determining a threat Eₙ of the threat at the threat velocity;
comparing the threat Eₙ to the Eₐ of the armor plates to obtain a group of armor plates each having an Eₐ greater than or equal to the threat Eₙ;
determining the toughness of each armor plate in the group based on the values stored in the database for the plate's mass, area, and energy per armor area; and then
providing an output listing comprising armor requirements to defeat the threat at the threat velocity.

2. The method of claim 1, wherein:
(a) said data sufficient to determine Eₙ comprises a threat maximum diameter and a threat mass, and said determining Eₙ at said threat velocity comprises calculating said kinetic energy of the threat and said projected area of the threat; or
(b) said data sufficient to determine Eₙ comprises values for threat kinetic energy E and/or threat projected energy Eₙ that have already been determined for at least one threat velocity.

3. The method of claim 1, wherein said comparing step involves a safety factor to ensure that, for each armor plate in said group, Eₐ is sufficiently greater than said threat Eₙ.

4. The method of claim 1, wherein said input comprises inputting a set of multiple threats and further comprising determining which threat in the set has the greatest Eₙ, and then using said greatest Eₙ in said comparing step.

5. The method of claim 1, wherein said output listing comprises a minimum plate weight set of a given size to defeat the threat.

6. The method of claim 1,
wherein said input comprises inputting a set of multiple threats and further comprising determining which threat in the set has the greatest Eₙ, and then using said greatest Eₙ in said comparing step; and
wherein said output listing comprises a list of all armor plates in said group and an identification of the threat from the set with the greatest Eₙ.

7. A method of selecting an armor system based on a threat having a given standoff distance, the method comprising:
providing a database comprising (1) a listing of armor plates, each having associated therewith a mass, an area, and an energy per armor area Eₐ; and (2) a listing of ballistic threats, each having associated therewith ballistics information sufficient to determine a threat velocity at a given standoff distance and data sufficient to determine threat projected energy, Eₙ, presented by the threat at a given velocity, wherein Eₙ is a kinetic energy of the threat divided by a projected area of the threat;
receiving an input comprising a threat and a standoff distance;
determining a threat velocity from the standoff distance;
determining a threat Eₙ of the threat at the threat velocity;
comparing the threat Eₙ to the Eₐ of the armor plates to obtain a group of armor plates each having an Eₐ greater than the threat Eₙ;
determining the toughness of each armor plate in the group based on the values stored in the database for the plate's mass, area, and energy per armor area; and then
providing an output listing comprising armor requirements to defeat the threat at the standoff distance.

8. The method of claim 7, wherein:
(a) said data sufficient to determine Eₙ comprises a threat maximum diameter and a threat mass, and said determining Eₙ at said threat velocity comprises calculating said kinetic energy of the threat and said projected area of the threat; or
(b) said data sufficient to determine Eₙ comprises values for threat kinetic energy E and/or threat projected energy Eₙ that have already been determined for at least one threat velocity.

9. The method of claim 7, wherein said comparing step involves a safety factor to ensure that, for each armor plate in said group, Eₐ is sufficiently greater than said threat Eₙ.

10. The method of claim 7, wherein said input comprises inputting a set of multiple threats and further comprising determining which threat in the set has the greatest Eₙ, and then using said greatest Eₙ in said comparing step.

11. The method of claim 7, wherein said output listing comprises a list of all armor plates in said group.

12. The method of claim 7,
wherein said input comprises inputting a set of multiple threats and further comprising determining which threat in the set has the greatest Eₙ, and then using said greatest Eₙ in said comparing step; and
wherein said output listing comprises a list of all armor plates in said group and an identification of the threat from the set with the greatest Eₙ.

13. A method of selecting an armor system based on a threat at muzzle velocity, the method comprising:
providing a database comprising (1) a listing of armor plates, each having associated therewith a mass, an area, and an energy per armor area, Eₐ; and (2) a listing of ballistic threats, each having associated therewith data sufficient to determine threat projected energy, Eₙ, at a muzzle velocity of the threat;
receiving an input comprising a threat;
determining a threat Eₙ of the threat at the threat muzzle velocity;
comparing the threat Eₙ to the Eₐ of the armor plates to obtain a group of armor plates each having an Eₐ greater than the threat Eₙ;
determining the toughness of each armor plate in the group based on values stored in the database for the plate's mass, area, and an energy per armor area; and then
providing an output listing comprising the armor plate in the group having the greatest toughness.

14. The method of claim 13, wherein said data sufficient to determine Eₙ comprises a threat maximum diameter, a threat mass, and said threat muzzle velocity, and said determining Eₙ comprises calculating said kinetic energy of the threat and said projected area of the threat.

15. The method of claim 13, wherein said comparing step involves a safety factor to ensure that, for each armor plate in said group, Eₐ is sufficiently greater than said threat Eₙ.

16. The method of claim 13, wherein said input comprises inputting a set of multiple threats and further comprising determining which threat in the set has the greatest Eₙ, and then using said greatest Eₙ in said comparing step.

17. The method of claim 13, wherein said output listing comprises a list of all armor plates in said group.

18. The method of claim 13,
wherein said input comprises inputting a set of multiple threats and further comprising determining which threat in the set has the greatest Eₙ, and then using said greatest Eₙ in said comparing step; and
wherein said output listing comprises a list of all armor plates in said group and an identification of the threat from the set with the greatest Eₙ.
